(19) United States
(12) Patent Application Publication
(10) Pub. No.: US 2006/0061254 A1
(43) Pub. Date: Mar. 23, 2006

(54) Field emission lighting device

(75) Inventor: Ga-Lane Chen, Fullerton, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/193,891

(22) Filed: Jul. 29, 2005

(30) Foreign Application Priority Data
Sep. 22, 2004 (CN) 200410051672.1

(51) Int. Cl. H01J 1/62; H01J 63/04

(52) U.S. Cl. 313/495

(57) ABSTRACT

A lighting device includes a cathode (11), a cover (12), an insulation layer (13), an emitter base (18), a niobium tip (19), a phosphor layer (15), an anode (16) and a silicon oxide layer (17). The cover is formed on the cathode. The insulation layer is formed on the cover. The emitter base is formed on the insulation layer. The niobium tip is formed on the emitter base. The phosphor layer is formed above the niobium tip. The anode is formed on the phosphor layer. The silicon oxide layer is formed on the anode. Each of the niobium tips may be closely combined with the emitter base. The combined niobium tips and the emitter base may be subjected to relatively high voltage electrical fields without being damaged.

### FIELD OF THE INVENTION

The present invention relates to electronic lighting technology, and particularly to a lighting device employing electron emission.

### BACKGROUND OF THE INVENTION

Various lighting technologies provide substitutes for sunlight in the 425-675 nm spectral region. In this spectral region, sunlight is most concentrated, and human eyes have evolved to be most sensitive. Technologies for efficiently creating visible light are continuously being developed. Such development may be viewed as the history of lighting.

A graph quantifying an aspect of the recent history of lighting is shown in FIG. 5. The vertical axis indicates luminous efficiency, in units of lumens per watt (“lumen” being a measure of light which factors in the human visual response to various wavelengths). The horizontal axis indicates time, in units of years A.D.

Three traditional lighting technologies are combustion, incandescence and high intensity discharges (HID). The progress of luminous efficiency of combustion, incandescence and HID technology are respectively represented by lines 30, 32, 34 in FIG. 5. The luminous efficiencies of these technologies have made significant gains over the past 150 years. However, the progress appears to have virtually stalled in recent years. What is needed, therefore, is a lighting device with high luminous efficiency.

### SUMMARY

A first preferred embodiment provides a lighting device including a cathode, a cover, an insulation layer, an emitter base, a niobium tip, a phosphor layer, an anode and a silicon oxide layer. The cover may be on the cathode. The insulation layer may be on the cover. The emitter base may be on the insulation layer. The niobium tip may be adjoining the emitter base. The phosphor layer may be above the niobium tip. The anode may be on the phosphor layer. The silicon oxide layer may be on the anode.

A second preferred embodiment provides a lighting device including a non-conductive substrate, a cover, a cathode, an insulation layer, an emitter base, a niobium tip, a phosphor layer, an anode on the phosphor layer and a silicon oxide layer. The cover may be on the non-conductive substrate. The cathode may be on the cover. The insulation layer may be on the cathode. The emitter base may be on the insulation layer. The niobium tip may be adjoining the emitter base. The phosphor layer may be above the niobium tip. The anode may be on the phosphor layer. The silicon oxide layer may be on the anode.

Preferably, the emitter base defines a diameter in the range of about 10 nanometers to about 100 nanometers. The niobium tip defines a bottom diameter essentially equal to the diameter of the emitter base. The niobium tip defines an upper diameter in the range of about 0.5 nanometers to about 10 nanometers. The emitter base and the niobium tip together define a height in the range of about 100 nanometers to about 2000 nanometers.

Each of the niobium tips may be closely combined with the emitter base. Because the combined niobium tips and the emitter base have good mechanical strength, excellent field-emission capability and good Young's modulus, the combined niobium tips and the emitter base can be subjected to relatively high voltage electrical fields without being damaged.

A high voltage electrical field may ensure a high current of field emission. The high current of field emission gives the lighting device a high luminosity, with visible light having satisfactory brightness being obtained. Therefore the lighting device with the niobium tips and the emitter base may emit a light having relatively high brightness. The brightness is about 10 to about 1000 times that of a comparable light emitting diode (LED) or high intensity discharge (HID) lamp.

Other advantages and novel features of the embodiments will become more apparent from the following detailed description when taken in conjunction with the accompanying drawings, in which:

### BRIEF DESCRIPTION OF THE DRAWINGS

FIG. 1 is a schematic, cross-sectional view of a lighting device in accordance with a first preferred embodiment of the present invention;

FIG. 2. is an enlarged view of an emitter sub-assembly of the lighting device of FIG. 1;

FIG. 3 is a schematic, cross-sectional view of a lighting device in accordance with a second preferred embodiment of the present invention;

FIG. 4 is an enlarged view of an emitter sub-assembly of the lighting device of FIG. 3; and

FIG. 5 is a graph of luminous efficiencies over a period covering the recent history of lighting technology.

### DETAILED DESCRIPTION OF PREFERRED EMBODIMENTS

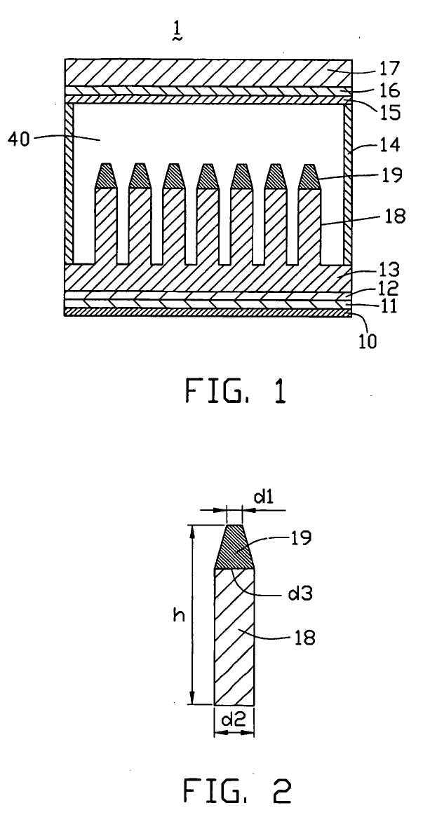

Referring to FIG. 1, a first preferred embodiment provides a lighting device 1 including a substrate 10, a cathode 11, a cover 12, an insulation layer 13, at least one base 18, one or more niobium tips 19, a phosphor layer 15, an anode 16 a sidewall 14 and a silicon oxide layer 17.

The substrate may be made of a material such as metal or metal alloy. The metal may be silver (Ag) or copper (Cu). Such metal or metal alloy substrate may be smooth, to facilitate formation of the cathode 11.

The cathode 11 formed on the substrate may be an electrically conductive material selected from the group consisting of copper (Cu), silver (Ag) and gold (Au). The cathode 11 may be preferably formed to have a thickness of less than 1 micrometer.

The cover 12 may be a silicon layer formed by a depositing process. The formed cover 12 may serve as a nucleation layer on the cathode 11. The nucleation layer may have a relatively small thickness, preferably less than 1 micrometer. Such nucleation layer provides environment for nucleation of the insulation layer 13. Such nucleation facilitates the deposition of the insulation layer 13 on the cover 12.

The insulation layer 13 is preferably deposited with silicon carbide (i.e., SiC), and is deposited on the cover 12. The insulation layer 13 is deposited with, for example, the same material as the emitter base 18. Preferably, the insulation layer 13 and the emitter base 18 are simultaneously formed as a whole. Two process steps may achieve this formation. In the first process step, a relatively thick silicon carbide layer is deposited by a chemical vapor deposition method, a plasma enhanced chemical vapor deposition method or an ion beam sputtering method. In the second process step, the deposited silicon carbide layer is partially etched. After the etching step, the remaining silicon carbide layer includes the insulation layer 13 and the emitter base 18 on the insulation layer 13.

The emitter base 18 may be a silicon carbide cylinder on the insulation layer 13. Each of the niobium tips 19 may have a cone shape, and may be deposited on the emitter base 18. The niobium tips 19 may be deposited by a sputtering method, a magnetron sputtering method, an ion beam sputtering method, a dual ion beam sputtering method, or another kind of glow discharge deposition method. Additionally, the niobium tips 19 may be arrayed on and adjoining the emitter base 18.

A bias voltage may be applied to the cathode 11, so that an electrical field is established. The electrical field drives electrons out of each of the niobium tips 19 to the phosphor layer 15. The phosphor layer 15 includes a phosphor material. The phosphor material generates visible light after being bombarded with the electrons.

The electrons are emitted to the phosphor layer 15 through, for example, a vacuum. The vacuum may be located in a space 40 between the anode 16 and the cathode 11. In particular, the space 40 may be cooperatively defined by the niobium tips 19, the sidewall 14, the insulation layer 13 and the phosphor layer 15. The phosphor layer 15 is spaced apart from the niobium tips 19, so that a completely uninterrupted portion of the space 40 exists between the anode 16 and the cathode 11.

The anode 16 may be deposited by using a mixture of argon and oxygen gases, and, in a DC reactive sputtering technique or an RF reactive sputtering technique. The deposited anode 16 may be an indium tin oxide (ITO) layer.

The silicon oxidelayer 17 may be a transparent layer on the anode 16. The transparent layer may be a transparent glass plate. The silicon oxide layer 17 is deposited by a DC reactive sputtering technique or an RF reactive sputtering technique. In such deposition, a mixture of argon and oxygen gases is used.

Referring to FIG. 2, the emitter base 18 may define a diameter d2 in the range of about 10 nanometers to about 100 nanometers. Preferably, each of the niobium tips 19 defines a bottom diameter d3 essentially equal to the diameter d2 of the emitter base 18. Each of the niobium tips 19 defines an upper diameter d1 in the range of about 0.5 nanometers to about 10 nanometers, and defines an aspect ratio in the range from about 10 to about 4000, and preferably from about 20 to about 400. The emitter base 18 and a corresponding single niobium tip 19 together define a height in the range of about 100 nanometers to about 2000 nanometers.

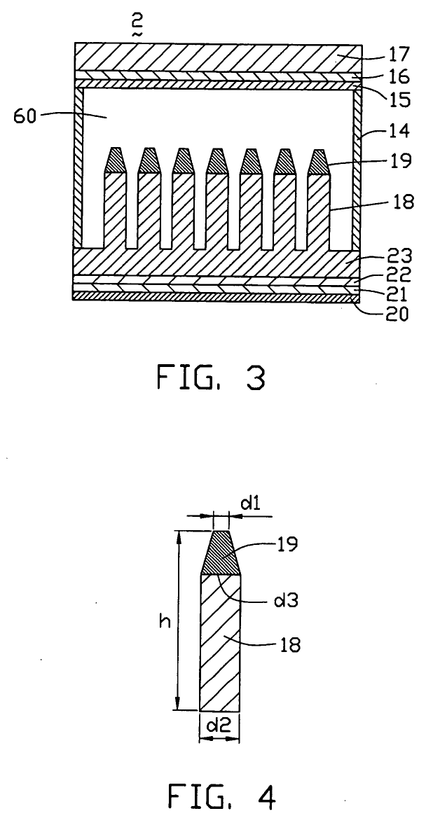

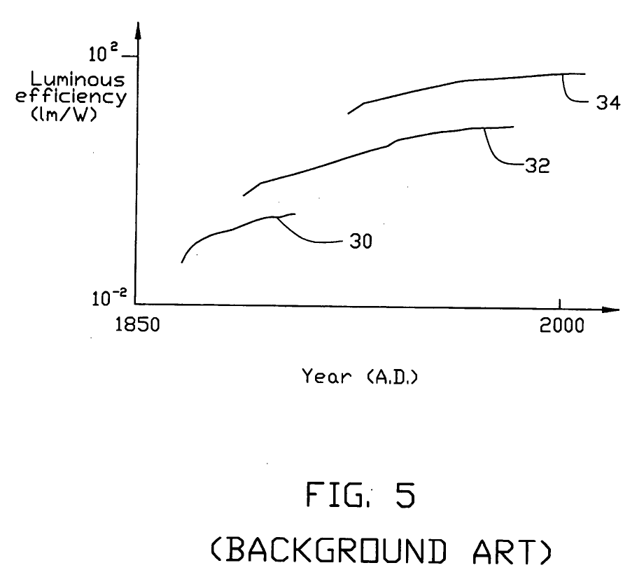

Referring to FIG. 3, a second embodiment provides a lighting device 2 including a non-conductive substrate 20, a cover 21, a cathode 22, an insulation layer 23, at least one base 18, one or more niobium tips 19, a phosphor layer 15, an anode 16, a sidewall 14 and a silicon oxide (SiO₂ or SiOₓ) layer 17.

The non-conductive substrate may be made of a material selected from the group consisting of silicon and glass. The cover 21 may serve as a nucleation layer formed on the non-conductive substrate.

The cathode 22 may be formed on the cover 21, and may be formed of an electrically conductive material selected from the group consisting of copper (Cu), silver (Ag) and gold (Au). The cathode 11 is preferably formed to have a thickness of less than 1 micrometer.

The insulation layer 23 is preferably deposited with silicon carbide (i.e., SiC), and is deposited on the cathode 22. The insulation layer 23 is deposited with, for example, the same material as the emitter base 18. Preferably, the insulation layer 23 and the emitter base 18 are simultaneously formed as a whole. Two process steps may achieve this formation. In the first process step, a relatively thick silicon carbide layer is deposited by a chemical vapor deposition method, a plasma enhanced chemical vapor deposition method or an ion beam sputtering method. In the second process step, the deposited silicon carbide layer is partially etched. After the etching step, the remaining silicon carbide layer includes the insulation layer 23 and the emitter base 18 on the insulation layer 23.

The emitter base 18 may be a silicon carbide cylinder on the insulation layer 23. Each of the niobium tips 19 may have a cone shape, and may be deposited on the emitter base 18. The niobium tips 19 may be deposited by a sputtering method, a magnetron sputtering method, an ion beam sputtering method, a dual ion beam sputtering method and or another kind of glow discharge deposition method. Additionally, the niobium tips 19 may be arrayed on and adjoining the emitter base 18.

A bias voltage may be applied to the cathode 22, so that an electrical field is built up. The electrical field drives the electrons out of each of the niobium tips 19, and then to the phosphor layer 15. The phosphor layer 15 includes a phosphor material. The phosphor material generates visible light after being bombarded with the electrons.

The electrons are emitted to the phosphor layer 15 through, for example, a vacuum. The vacuum may be located in a space 40 between the anode 16 and the cathode 22. Such space 40 may be defined by surrounding the niobium tips 19 with the sidewall 14, the insulation layer 13 and the phosphor layer 15. The phosphor layer is spaced apart from the niobium tips 19, so that the space 40 is left between the anode 16 and the cathode 22.

The anode 16 may be deposited by using a mixture of argon and oxygen gases, in a DC reactive sputtering technique or an RF reactive sputtering technique. The deposited anode 16 may be an indium tin oxide (ITO) layer.

The silicon oxide layer 17 may be a transparent layer on the anode 16. The transparent layer may be a transparent glass plate. The silicon oxide layer 17 is deposited by a DC reactive sputtering technique or an RF reactive sputtering technique. In such deposition, a mixture of argon and oxygen gas is used.

Referring to FIG. 4, the emitter base 18 may define a diameter d2 in the range of about 10 nanometers to about 100 nanometers. Preferably, each of the niobium tips 19 defines a bottom diameter d3 essentially equal to the diameter d2 of the emitter base 18. Each of the niobium tips 19 defines an upper diameter d1 in the range of about 0.5 nanometers to about 10 nanometers, and defines an aspect ratio in the range from about 10 to about 4000, and preferably from about 20 to about 400. The emitter base 18 and a corresponding single niobium tip 19 together define a height h in the range of about 100 nanometers to about 2000 nanometers.

In the first embodiment and second preferred embodiment, each of the niobium tips 19 may be closely combined with the emitter base 18. Because the combined niobium tips 19 and the emitter base 18 have good mechanical strength, excellent field-emission capability and good Young's modulus, the combined niobium tips 19 and the emitter base 18 can be subjected to relatively high voltage electrical fields without being damaged.

A high voltage electrical field may ensure a high current of field emission. The high current of field emission gives the lighting device a high luminosity with visible light having satisfactory brightness being obtained. Therefore the lighting device 1 and the lighting device 2 with the niobium tips 19 and the emitter base 18 may emit light having relatively high brightness. The brightness is about 10 to about 1000 times that of a comparable light emitting diode (LED) or a high intensity discharge (HID) lamp.

The lighting device of the first and the second preferred embodiments may be applied in various illumination products. For example, the lighting device may be employed in a headlight of an automobile.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A lighting device comprising:
a cathode;
a cover on the cathode;
an insulation layer on the cover;
an emitter base on the insulation layer;
a niobium tip adjoining the emitter base;
a phosphor layer above the niobium tip;
an anode on the phosphor layer; and
a silicon oxide layer on the anode.

2. The lighting device of claim 1, wherein the emitter base defines a diameter in the range of about 10 nanometers to about 100 nanometers.

3. The lighting device of claim 2, wherein the niobium tip defines a bottom diameter essentially equal to the diameter of the emitter base.

4. The lighting device of claim 1, wherein the niobium tip defines an upper diameter in the range of about 0.5 nanometers to about 10 nanometers.

5. The lighting device of claim 1, wherein the emitter base and the niobium tip together define a height in the range of about 100 nanometers to about 2000 nanometers.

6. A lighting device comprising:
a substrate;
a cover on the substrate;
a cathode on the cover;
an insulation layer on the cathode;
an emitter base on the insulation layer;
a niobium tip adjoining the emitter base;
a phosphor layer above the niobium tip;
an anode on the phosphor layer; and
a silicon oxide layer on the anode.

7. The lighting device of claim 6, wherein the emitter base defines a diameter in the range of about 10 nanometers to about 100 nanometers.

8. The lighting device of claim 7, wherein the niobium tip defines a bottom diameter essentially equal to the diameter of the emitter base.

9. The lighting device of claim 6, wherein the niobium tip defines an upper diameter in the range of about 0.5 nanometers to about 10 nanometers.

10. The lighting device of claim 6, wherein the emitter base and the niobium tip together define a height in the range of about 100 nanometers to about 2000 nanometers.

11. A lighting device comprising:
an anode disposed in the lighting device and capable of lighting after bombarding of electrons; and
an emitter assembly spaced from the anode in the lighting device for emitting the electrons to bombard the anode via at least one niobium tip formed thereon.

12. The lighting device of claim 11, wherein the emitter assembly defines a base where the at least one niobium tip is formed thereon, the base defines a diameter in the range of about 10 nanometers to about 100 nanometers.

13. The lighting device of claim 12, wherein the niobium tip defines a bottom diameter essentially equal to the diameter of the base.

14. The lighting device of claim 11, wherein the niobium tip defines an upper diameter in the range of about 0.5 nanometers to about 10 nanometers.

15. The lighting device of claim 12, wherein the base and the niobium tip together define a height in the range of about 100 nanometers to about 2000 nanometers.

16. The lighting device of claim 11, further comprising a phosphor layer formed on the anode for lighting of the anode.
